(19) United States
(12) Patent Application Publication
(10) Pub. No.: US 2007/0005323 A1
(43) Pub. Date: Jan. 4, 2007

(54) System and method of automating the addition of programmable breakpoint hardware to design models

(76) Inventors: Aaron Thomas Patzer, Austin, TX (US); Joseph Anthony Perrie III, Austin, TX (US); Steven Leonard Roberts, Cedar Park, TX (US); Todd Swanson, Round Rock, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/171,760

(22) Filed: Jun. 30, 2005

(51) Int. Cl. G06F 17/50

(52) U.S. Cl. 703/14

(57) ABSTRACT

Hardware logic for generating breakpoint signals based on state changes in observed (“tagged”) hardware resource of a design under test is automatically generated and added to the simulation model of the design under test. These breakpoints halt simulation when a user programmable event, such as an assertion, test-case failure, or trigger occurs. Allowing the end-user to define the register values used in comparison to or timing of tagged resources, results in breakpoints that can be created, changed, enabled, or disabled without rebuilding the simulation model. Because the breakpoint logic is in-circuit, it takes full advantage of the acceleration made possible by hardware simulators, while providing an interactive environment for both functional hardware verification and software development on the simulated hardware mode.

### BACKGROUND OF THE INVENTION

1. Technical Field

The present invention relates in general to a system and method for automatically adding hardware breakpoint logic to a hardware design model. In particular, the present invention relates to a system and method that automatically adds breakpoint hardware to the design and enables the user to set breakpoints without having to reload the design in the hardware simulator.

2. Description of the Related Art

With the ever increasing complexity and size (in terms of gate counts) of modern very large scale integrated circuits (VLSI), verifying the correctness of a design's architecture and implementation has become increasingly difficult and time consuming. Detecting design faults early is crucial. The longer an error takes to be detected and corrected, the more time consuming and costly a redesign becomes. Moreover, the longer an error takes to be detected and corrected, the longer it takes for the product to reach the marketplace.

Cycle simulation is a crucial and widely used technique for verifying hardware designs. A clock period (cycle) serves as the time quanta for simulation. During cycle simulation, the various hardware components are simulated on a cycle-by-cycle basis. Cycle simulation is thus able to identify particular hardware design errors, such as timing errors, that are difficult or impossible for software-based emulators to identify. Cycle simulation begins by constructing a gate or register transfer level (RTL) model of the design. The RTL model is often created using a synthesizable hardware description language (HDL). The inputs of this model are then stimulated with test vectors. Stimulating the model with test vectors causes the state of the machine—broadly defined as the values contained in the registers, latches, and memory elements—to change.

In software-based cycle simulation, simulation is executed on one or more computer systems with the state changes occurring in values stored in random access memory (RAM) of the computer systems. This form of simulation allows cycle-by-cycle visibility of the state to external checking mechanisms. These external checking mechanisms (also called external software checkers and test-benches) monitor the state and state changes of the simulated machine to ensure proper functional operation. Should a violation of one of the rules encoded in one of the checking mechanisms occur, the simulation can be halted and a trace of the events leading up to the error can be established.

A challenge of software-based cycle simulation is that the process can be very slow. Simulating complex designs with large gate counts exacerbates this challenge. Simulating a complex design often only allows simulating from tens to a few hundred cycles per second. In an era of gigahertz-class computer systems, simulating a large complex design can mean that months of simulation are required to simulate just one second of actual hardware time. As a result, errors which occur deep in the design which are visible only after thousands or millions of cycles of operation may go undetected. Failing to detect these errors often results in hardware being produced, at the cost of millions of dollars, that has errors.

Another challenge of slow simulation speeds is that it hinders software development for the software being developed to run on the hardware that is being designed. Software development occurs concurrently with hardware development. Running and debugging this software on an accurate hardware model is crucial to ensuring proper operation of the software. Slow simulation of hardware also hinders the development of related software. Because software may rely on very specific features and functions implemented in hardware, it is crucial to run and debug this software inside a cycle-accurate hardware simulation

In order to accelerate the process of cycle simulation, special purpose hardware is frequently used to simulate the design under test (DUT). Using a special purpose hardware simulator, the hardware design to be simulated is mapped into the gates and arrays of custom ASICs or FPGAs for simulation execution.

A challenge of using a specialized hardware simulator is minimizing communications between the hardware simulator and a host computer system. While these hardware simulators are often hundreds or thousands of times faster than using software-based cycle simulation, maximum performance can only be achieved when communication between the hardware simulator and the host across a service interface is minimized. A challenge of minimizing this communication is that cycle-by-cycle state changes are no longer visible to either external function checkers or to the software developer. As a result of the restricted debugging information available using hardware simulation, hardware simulation has traditionally been used in a limited fashion and predisposed to programs that are self-checking.

One approach to maximize simulation speed while minimizing communication between the host and the hardware simulator is writing some functional checks in a synthesizable HDL and compiling the functional checks into the simulation model. Because these “in-circuit” checks are hardware-based, they are simulated at the same speed as the design under test and do not require communication with the host until a test fails. Unfortunately, there are significant challenges using in-circuit checks. First, the in-circuit checks are limited in functionality and complexity as compared to software checkers that are written in a higher level language, such as C or C++. Second, in-circuit checks are expensive in terms of time and resources to prepare as compared to using software checkers. Finally, in-circuit checks require an intimate working knowledge of the hardware design—this is a skill that is not always available in verification teams whose staff may be more software oriented.

An alternative to writing an entire in-circuit check in hardware is to write simpler logic that defines a “breakpoint” signal or event. A breakpoint halts (freezes) the emulator when an event of interest (such as an assertion, test failure, or trigger) occurs. Once halted, the state of the simulator can be probed by sophisticated host-based software checkers and the state can be compared against expected values to ensure correct functional operation. Instead of having external software slow the simulation by probing on a cycle-by-cycle basis, breakpoints allow the simulator to run at full-speed until something interesting occurs.

In addition to facilitating accelerated hardware verification, breakpoints are also useful to software developers who need to test and debug their code on simulated hardware. While simulators allow simulation of millions of clock cycles necessary to run real software, the communications bottleneck prevents cycle-by-cycle visibility of key hardware resources without dramatically impacting the speed of the simulation. However, visibility of hardware resources such as general purpose registers (GPRs), the instruction counter (IC), the memory address register (MAR), and other resources are crucial to debugging software.

Instead of displaying the contents of all hardware resources every cycle, in-circuit hardware breakpoints can be used in a similar fashion to how breakpoints are used in a software debugger. Namely, a developer breaks on an interesting event and compares the state of the machine to its expected value.

A challenge to using breakpoints is that they are defined beforehand and are time consuming to change in order to break on a different event or signal. Breakpoints are defined beforehand, compiled into the simulation model, and mapped to a hardware simulator. Performing these steps is a lengthy process, often taking several hours to complete. If the developer wants different breakpoints during the course of debugging, the model must be recompiled. Finally, an additional challenge to using breakpoints is that they also require hardware expertise in order to write.

What is needed, therefore, is a system and method that allows breakpoints to be enabled and disabled as needed. Additionally, what is needed is a system and method that defines new breakpoints during hardware simulation without needing to recompile the hardware model.

### SUMMARY

A system and method addressing the foregoing challenges has been discovered that allows breakpoints to be enabled and disabled as needed. Additionally, the system and method defines new breakpoints during hardware simulation without needing to recompile the hardware model.

Hardware that enables programmable breakpoints is automatically generated. Resources (i.e., registers, instruction counter, memory areas, signals, nets, busses, etc.) included in the design under test (DUT) are identified as being useful for debugging purposes. These resources are “tagged” in the hardware description language (HDL) in a way so that the tags are retained in the netlist model.

The HDL is compiled into a netlist that includes the tags corresponding to the identified resources. A software program traverses the design to locate the tagged resources. For each tagged resource, logic is automatically constructed to generate signals based the resource. The signals are generated based on a comparison to, a change in, or the relative timing of the tagged resource. The values used for comparison to the tagged resource (or for comparison to a tagged resource triggered cycle count) are stored in registers that are also resources of the simulation model. These registers are programmable by using a standard put( ) command—provided by the simulator—to set a value. This value is retained in the simulated model during simulation until explicitly reprogrammed or disabled.

Signals output from the automatically generated logic associated with each tagged resource comprise “basic events.” For example, a basic event could be defined as a particular register being equal to a particular value (e.g., IAR=0x1234). This basic event would be triggered when IAR equals the hexadecimal value 0x1234. Basic events may be used as breakpoints. In addition, basic events may be combined to form more complex breakpoints.

The automatic generation of basic events eliminates the effort and HDL expertise required to manually design breakpoint logic and hardware checkers. At the same time, the automatically generated breakpoint logic operates at in-circuit speeds to maximize simulator performance. Furthermore, the power and flexibility of software-based checkers is harnessed but only when a particular event occurs that triggers a breakpoint. This avoids cycle-by-cycle observation over a relatively slow communication interface.

By using programmable values that are set using standard puto commands allows breakpoints to be enabled, disabled, and changed whenever desired without having to recompile the simulation model. In this manner, the speed of the hardware simulator is more fully harnessed while allowing the flexibility and interactivity of a standard software debugger.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1A is a prior art depiction of a simulation using cycle-by-cycle interaction;

FIG. 1B is a depiction of a simulation using interaction as provided by the present invention;

FIG. 2 is a flowchart comparison of using the prior art methodology of simulation versus the interactive methodology provided by the present invention;

FIG. 3 is a diagram of simulating a design using simple simulation breakpoint resources provided by the interactive simulation methodology;

FIG. 4 is a diagram depicting simple breakpoint resources being combined to form more complex breakpoint resources;

FIG. 5 is a diagram showing an example of simple breakpoint resources being combined to form a more complex breakpoint resource;

FIG. 6 is a diagram of a switch that is loaded into the simulator in order to combine the simple breakpoint resources;

FIG. 7 is a flowchart depicting the creation of the hardware definition language for a model and the automatic attachment of breakpoint logic to the model;

FIG. 8 is a flowchart depicting the creation of the hardware design source and the automatic attachment of breakpoint logic through a netlist;

FIG. 9 is a flowchart depicting the addition of complex breakpoints to the design; and

FIG. 10 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

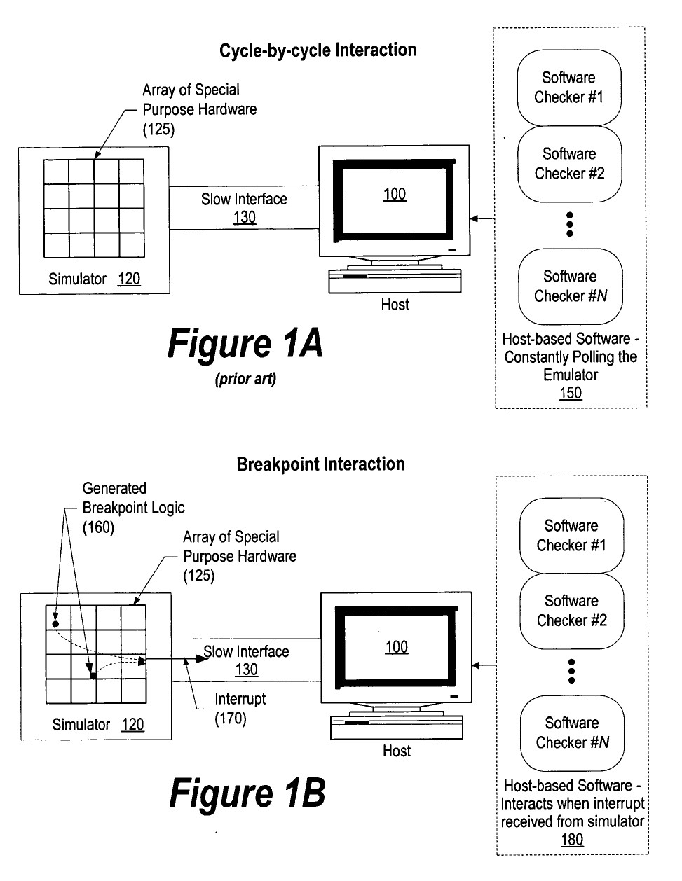

FIG. 1A is a prior art depiction of a simulation using cycle-by-cycle interaction. Host computer 100 is used to load a simulation model into hardware simulator 120 via a relatively slow interface (130) coupling simulator 120 to host computer 100. Using a hardware simulator, such as simulator 120, provides increased performance over using a software based simulator. The hardware being tested is mapped into gates and arrays 125 of custom Application-Specific Integrated Circuits (ASICs) or Field Programmable Gate Arrays (FPGAs) for execution on the hardware simulator. While execution on the hardware simulator is much faster than when using a software-based emulator, the traditional simulation approach is challenged by the relatively slow interface (130). In order to maximize performance, communication through interface 130 needs to be reduced, which means that cycle-by-cycle state changes are not visible to software checkers 150 running on the host computer.

FIG. 1B is a depiction of a simulation using interaction as provided by the present invention. Here, breakpoint logic 160 is automatically generated and incorporated into array 125. The user of host computer 100 can interactively set conditions that trigger breakpoint logic 160. For example, a breakpoint can be set to trigger when a register value (e.g., R0) reaches a certain value. The functional checks (e.g., check for whether a register is equal to a value) is automatically generated and incorporated into the hardware model that is loaded on the hardware simulator. Individual breakpoints can be interactively turned on and off from host computer 100 after the model is loaded. In addition, the values that trigger the breakpoints can also be set by a user operating the host computer system after the model is loaded in the hardware simulator without having to recompile the model. For example, after the model is loaded, the designer can turn on a breakpoint of a register that is used as a counter for an event. The designer can set the breakpoint to be when the register reaches 10 (meaning that 10 occurrences of the event have taken place). At this point the designer can use interface 130 to inspect certain values of the model (i.e., other register values, gate values, etc.). The designer can then reset the breakpoint, for example to 1000, and continue running the simulation. When the new value (1000) is reached, the simulator will be interrupted and the values in the simulator can once again be retrieved and inspected. In this manner, host based software 180 interacts with the simulator only when the simulator has been interrupted, rather than constantly polling values as was done in the prior art.

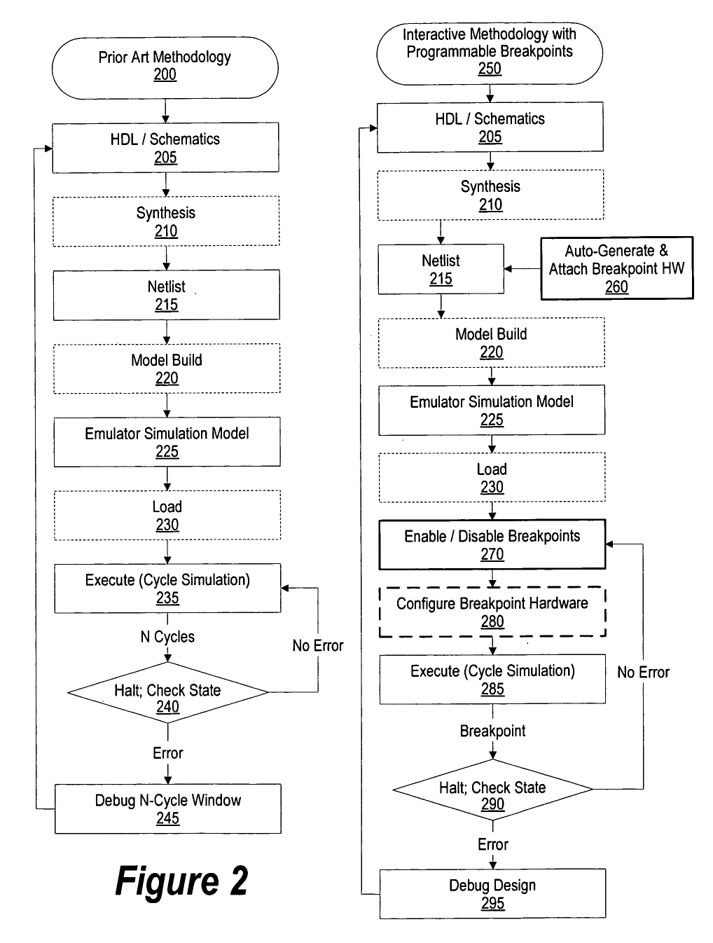

FIG. 2 is a flowchart comparison of using the prior art methodology of simulation versus the interactive methodology provided by the present invention. An overview of the prior art methodology commences at 200 whereupon, at step 205, the designer creates the hardware definition language (HDL) and schematics that describe the hardware design. At step 210, the HDL is synthesized to create netlist 215. A netlist is a version of an electronic circuit on a CAD system consisting of all of the circuit element names/reference designators, listed with their input and output signal names. A netlist is typically in a format similar to:

<element name><input signals><output signals>

Netlists are the primary form of a circuit used for simulation. Schematic versions of circuits are compiled into netlists before simulation or manufacture is possible. The netlist is used to create a model of the hardware at step 220. The model is used on an emulator (hardware simulator) at step 225. At step 230, the model is loaded on the simulator. At step 235 the model is executed on the simulator where cycle simulation is performed. After a predetermined number of cycles (N cycles), set by the designer, are performed, a check is made to see whether the design has errors. At 240, the simulation is halted and the state of the model is checked for errors. If there are no errors, the processing loops back to continue the simulation and simulate another N cycles of the hardware design. Simulation continues until the hardware designer is confident that any errors in the design have been uncovered. When an error is found, the designer retrieves the values in the array of special purpose hardware in the simulator and attempts to debug the cycle window (i.e., how the error developed with the preceding N cycles). Decreasing the number of cycles makes the window smaller for identifying the error but increases the time needed to simulate the design. Conversely, increasing the number of cycles decreases the time needed for simulation but makes the debug window larger, thus increasing the time and effort needed to identify the error in any given debug window.

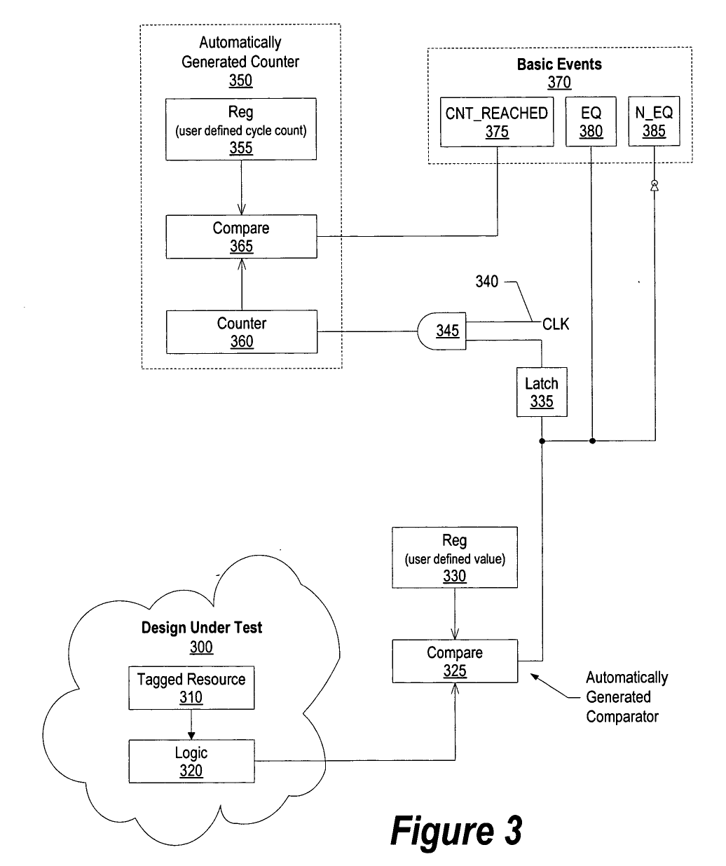

Turning now to the interactive methodology provided by the present invention that commences at 250. The flowchart commencing at 250 highlights the differences between the improved methodology and that used in the prior art. Additional steps for using the interactive methodology with programmable breakpoints are highlighted. Steps that are not highlighted are essentially the same as those previously described with the same reference numbers in the prior art description above. When the netlist is generated, breakpoint hardware is automatically generated and attached to the netlist at step 260. Now, when the model is built and loaded, the model includes the breakpoint hardware design as well. More detailed descriptions of the breakpoint hardware are provided in hereinafter (see FIGS. 3-5). After the model is loaded, in step 270, the designer can enable and disable the various breakpoints that were automatically generated and attached in step 260. For example, the designer can enable a breakpoint of a register that is used to count a particular event. At step 280, the breakpoint hardware is configured. This configuration includes setting the breakpoint condition, also referred to as a “trigger,” that is used to initiate the breakpoint. For example, the register breakpoint can be configured to be triggered when the register reaches a value of 10. After the breakpoints have been enabled and configured, the simulator is started whereupon cycle simulation occurs at step 285 until a breakpoint is reached (i.e., the enabled register is equal to 10). When a breakpoint occurs, the simulator is halted and the designer is able to check the state of the simulation using software checkers that analyze the values currently existing in the model (decision 290). If an error has occurred, the designer can chose whether to continue simulating the current design or go back to edit the hardware design in the HDL and recompile the model for further simulations by debugging the design at step 295 and looping back to the step 205. If the designer chooses to continue (i.e., no errors were encountered or simulation can continue using the current model despite errors that were encountered), then the methodology loops back to step 270 where the designer can choose to enable or disable breakpoints (step 270) and can configure the breakpoints by setting the conditions that trigger the enabled breakpoints. Time is saved by interactively setting breakpoint conditions rather than blindly running a certain number of cycles. Hardware of interest, such as registers or gates, can be more closely analyzed with the simulator halting when the hardware reaches an interesting condition.

FIG. 3 is a diagram of simulating a design using simple simulation breakpoint resources provided by the interactive simulation methodology. Simulation of additional hardware is generated and included in the model for the various breakpoints that have been defined in the hardware being designed. As described in FIG. 2, above, these breakpoints can be turned on or off after the model is loaded in the simulator depending upon the hardware of interest.

Design under test (DUT) 300 includes the model of the hardware being simulated. Also included in the design under test are tagged resources 310. Resources, such as registers, instruction counter, memory areas, signals, nets, busses, etc., included in the design under test (DUT) are identified as being useful for debugging purposes. These resources are “tagged” in the hardware description language (HDL) in a way so that the tags are retained in the netlist model. Also included is logic 320 for analyzing the tagged resources.

When the breakpoint for a resource is turned “on,” the logic corresponding to the resource is used to provide data to the designer regarding both basic events as well as more complex events. The logic includes register 330 that the user of the simulation (designer, developer, etc.) can use to turn the breakpoint “on” or “off.” Comparator 325 is used to compare the value of the resource with a value supplied by the simulation user. For example, the simulation user might be interested in a hardware register when it reaches a certain value or when it contains a particular address. Comparator 325 is automatically generated due to the fact that this resource has been “tagged” as being potentially useful for debugging purposes. A simulated comparator, register 330, counter logic 350, and basic event logic 370 are generated for each tagged resource. However, the comparator, counter and basic event logic are only executed for those tagged resources with breakpoints that have been turned “on” by the simulation user turning the breakpoint. The comparator provides certain basic events 370 depending upon the value of the resource. The two basic events are either an “equal” condition 380 that is flagged when the user-programmed register value in register 330 is equal to the resource value, and a “not equal” condition 385 that is flagged when the user-programmed register value in register 330 is not equal to the resource value.

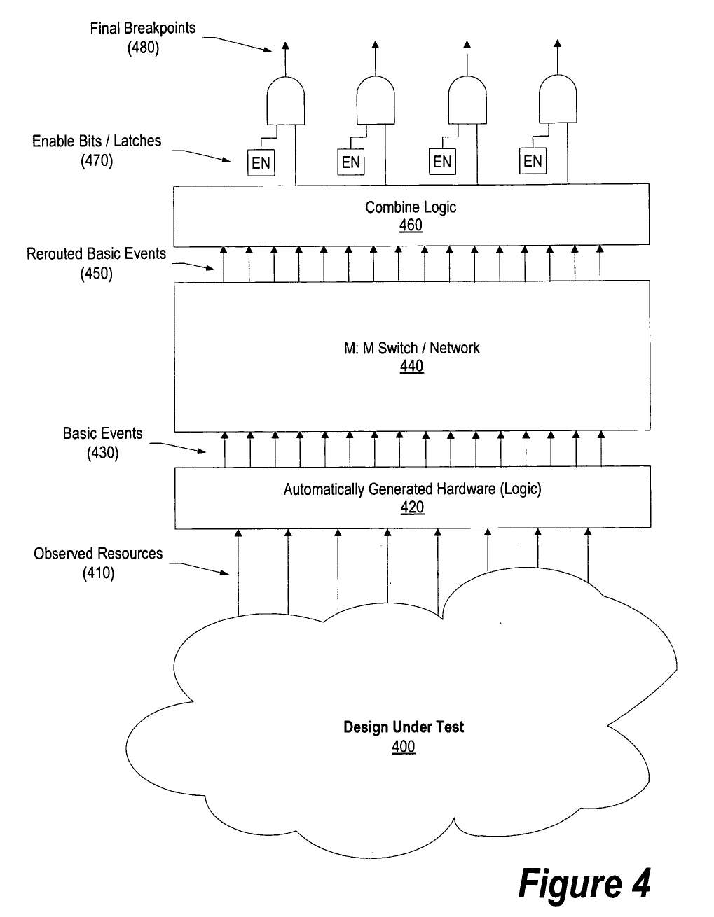

In addition, an EQUAL value from the comparator sets latch 335 whose output enables counter 360 to be incremented each clock cycle. Counter logic 350 is provided for each tagged resource. When clock signal 340 is reached and the latch is set, AND gate 345 sends a signal to counter 360 which is incremented accordingly. The value of counter 360 is compared to user defined register 355 to determine if the value being checked for (user defined register 330) has occurred a given number of times. Comparator 365 compares user defined register 355 with counter 360. The output from this comparison, CNT_REACHED 375, is set high when the counter reaches (is equal to) the user defined value. The combination of a comparator and the counter enables temporal breakpoints such as “HALT 12 cycles after instruction counter=0x99884” to be triggered off of the CNT_REACHED signal. A basic event, such as when a register is equal to a certain value or when a counter has reached a certain threshold, can serve as a breakpoint. When a breakpoint is reached, the simulation can be halted and the user of the simulation can analyze the state of the hardware being simulated at a point in time when a particular condition has occurred. For more advanced checking, however, the user may wish to define more complex breakpoint conditions, for example setting a breakpoint to occur when general purpose register 4 (GPR4) is equal to 0x1234 exactly 19 cycles after instruction counter (IC) is 0x998812 and translation look aside buffer flush condition is true (TLB_FLUSH=0x1). For these more advanced condition combinations, a switch and combination logic are used to combine basic events into more complex breakpoint conditions. One example of setting complex breakpoints is shown in FIGS. 4 through 6 and their corresponding descriptions.

While FIG. 3 provides one embodiment for the types of automatically generated (simulated) hardware that can be used, those of skill in the art will appreciate, after examining the present application, that many useful variations of automatically simulated hardware are possible. For example, multiple comparators and counters may be used. Also, hardware such as linear feedback shift registers (LFSRs) can be used in addition, or in place of, counters. In addition, comparators may provide for “less than” and “greater than” conditions in addition to equality conditions. The types and complexity of automatically generated hardware might also depend on the type of hardware being tested in the Design Under Test (DUT).

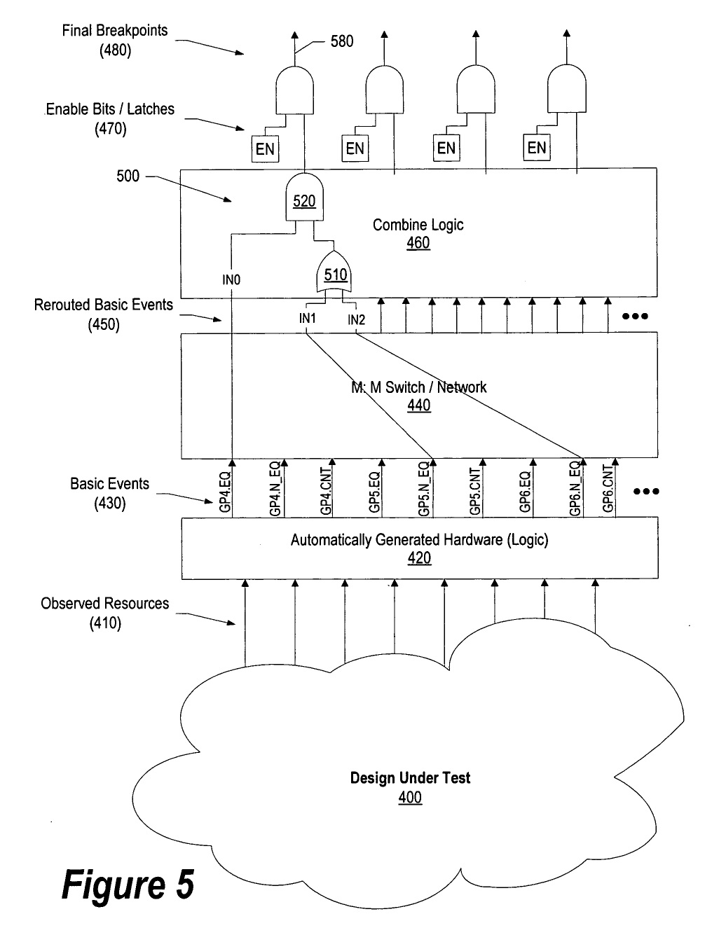

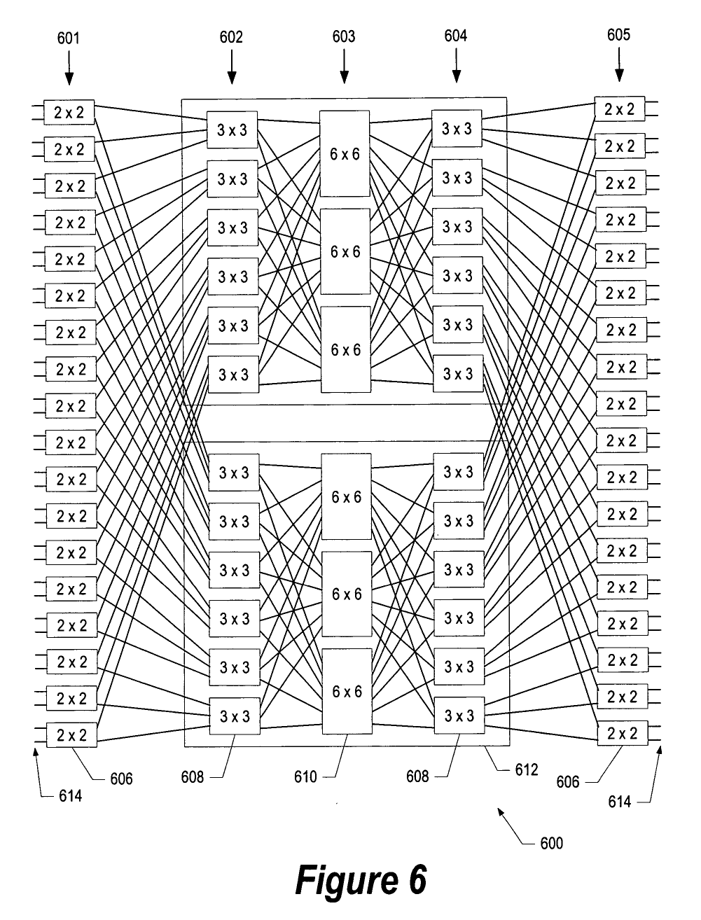

FIG. 4 is a diagram depicting simple breakpoint resources being combined to form more complex breakpoint resources. In order to combine arbitrary subsets of basic event signals, a non-blocking M:M space division network is used and the simulated hardware for the network is loaded in the model. This network will route any input port to any output port. By routing the appropriate basic events to output ports, the basic events can be ANDed and ORed by combinational logic to produce complex breakpoints. One implementation of a non-blocking M:M space division network (switch) is shown in FIG. 6. As shown in FIG. 4, complex breakpoints (final breakpoints 480) can be reconfigured simply by changing the state of switch 440 to route different basic events to different inputs of combine logic 460 (see FIG. 5 for an example of combine logic with inputs).

Design under test (DUT) 400 includes a number of tagged resources, such as registers, instruction counters, memory areas, signals, nets, busses, etc. For each tagged resource, simulated hardware 420 is automatically generated. When running a simulation, the breakpoints for some resources are turned on while others can be left off. When a breakpoint for a resource is turned on, it becomes an “observed resource” (410) The results and values maintained by observed resources 410 are analyzed using the simulated hardware that was automatically generated for these resources (see FIG. 3 and corresponding text for an example of simulated hardware automatically generated for a resource).

Results from automatically generated hardware 420 are referred to as “basic events” 430. Automatically generated hardware 420 provides basic events 430 to switch 440. As with the automatically generated hardware, switch 440 is also simulated and the hardware used to build the switch is included in the model. In order to combine basic events, simulated switch 440, such as a Benes switch, is automatically generated in order to reroute basic events as inputs to simulated combination hardware logic 460 (for an example of simulated combination hardware logic, see FIG. 5 and corresponding text. Like automatically generated hardware 420, the circuitry for combine logic 460 is simulated and included in the model. Results from combine logic 460 can be enabled or disabled using enable bits/latches 470. In order to turn on a particular combine logic, the corresponding enable bit (latch) is set. Enable bits (latches) 470 are user controlled so that the user of the hardware simulation can enable or disable a complex breakpoint defined in combine logic 460 simply by enabling or disabling the corresponding bit. This enables the user to disable/enable complex breakpoints without having to rebuild and reload the model. Final breakpoints 480 result from an AND operation between the enable bit and the output from the combine logic.

FIG. 5 is a diagram showing an example of simple breakpoint resources being combined to form a more complex breakpoint resource. FIG. 5 shows an example of combination logic that takes, as input, results (values) provided by automatically generated hardware 420. In the example shown, combine logic includes complex breakpoint logic 500. In the example, the complex breakpoint logic includes OR gate 510 and AND gate 520. OR gate 510 has two inputs, IN1 and IN2, that are mapped to basic events using switch 440. AND gate 520 also has two inputs, IN0 is shown as being routed, using switch 440, from one of the basic events, and the other input is the result of OR gate 510.

Various basic events are shown in FIG. 5. The events include a signal generated when general purpose register 4 is equal to a user supplied value (GP4.EQ), when general purpose register 4 is not equal to a user supplied value (GP4.EQ), when a counter corresponding to general purpose register 4 reaches user supplied threshold (GP4.CNT). The same signals (equal, not equal, counter) are shown for general purpose registers 5 and 6 (GP5 and GP6). In the example shown, switch 440 is used to route the GP4.EQ event to IN0 (input to AND gate 520), GP5.N_EQ and GP6_N_EQ to IN1 and IN2, respectively, of OR gate 510. In other words, in the example shown, final breakpoint 580 will be set when GP4 is equal to a value of interest AND either GP5 OR GP6 is not equal to values of interest. Using switch 440, different events can be routed to IN0, IN1, and IN2, depending upon the conditions that the simulation user is examining (see FIG. 6 and corresponding text for more detail regarding an example simulated switch 440 implemented using a Benes switch design.

It will be appreciated by those skilled in the art that the circuitry shown in combine logic 460 can be as complex or as simple as needed, based upon the hardware being simulated. In addition, an entire library of combination logic can be included in combine logic 460 with various permutations of combining basic events.

FIG. 6 shows a diagram of a rearrangeable non-blocking network in a Benes configuration. If configuration of the switch (network) occurs all at once, such as when the hardware simulator is halted, a rearrangeably non-blocking network such as a Benes configuration (as shown in FIG. 6) can be used. If one or more arbitrary inputs need to be routed to one or more arbitrary outputs on the fly, such as when the hardware simulator is running, without altering previously routed signals, a wide-sense or strictly non-blocking network may be used. For simplified control of the switch, an M-input, M-output network may be implemented such that M is a power to two.

In an alternative embodiment, inputs to the space division network can include signals other than the basic events produced by the automatically constructed hardware. This would allow both basic events, and other internal or external signals to be used to form complex breakpoints. The cost of a cross-connect switch of the type shown herein is related, among other things, to the number of switch points needed to implement the various switching modules used to construct the cross-connect switch. In the Benes approach, a switch is constructed with N input lines and N output lines. Each stage is constructed from switch modules having equal numbers of input and output lines, the number of such lines being determined by N.

To construct a cross-connect switch according to Benes with N>6, one first selects the size of the switch modules used to construct the center stage. If P is largest prime factor of N, then number of input (and output) lines, N_{c}, for each center stage switch module is chosen to be P if P>3. If P=3 and N is even, Nc is chosen to be 6. If P=3 and N is odd, Nc is chosen to be 3. Finally, if P=2 then Nc is chosen to be 4. If N is less than or equal to 6, a single N×N switch module is used to construct the cross-connect switch.

Having chosen N_{c}, one then decomposes N/N_{c} into its prime factors, fᵢ. The number of prime factors determines the number of stages in the cross-connect switch. In particular, if there are S prime factors, the cross-connect switch will have 2S+1 stages. The cross-connect switch is symmetric about the center stage which will be labeled as stage “O.” The stages on the output side of the center stage will be labeled with positive numbers, and the stages on the input side of the center stage will be labeled with negative numbers. Hence, stage i and stage −i are both constructed from fᵢ×fᵢ switch modules.

This methodology can be more easily understood with reference to the specific cross-connect switch shown in FIG. 6 at 600. Switch 600 is a 36×36 cross-connect switch. That is, it has 36 input lines 614 and 36 output lines 616. Since the largest prime factor of 36 is 3 and, since N=36 is even, Nc=6. That is, the center stage 603 of switch 600 is to be constructed from 6×6 switch modules 610. N/N_{c} is, therefore, equal to 6 which has prime factors of 2 and 3. Since there 2 prime factors, the switch will have 5 stages. The five stages are shown at 601 through 605 in FIG. 6. The first stage 601 and the fifth stage 605 are constructed from 18 2×2 switch modules 606. The second stage 602 and the fourth stage 604 are constructed 3×3 switch modules 608.

Although switch 600 has five stages, it may be viewed as a three-stage Clos switch in which the center stage is constructed from two 18×18 switch modules 612. Each switch module 612 is in turn a three stage switch having a first and third stages constructed from 3×3 switch modules and a center stage constructed from 6×6 switch modules.

The choice of which switch modules are used for the stages other than the center stage does not affect the total number of cross-points needed to construct a switch according to Benes. For example, an alternative 36×36 cross-connect switch could be constructed in which the first and fifth stages are constructed from 3×3 switch modules and the second and fourth stages are constructed from 2×2 switch modules.

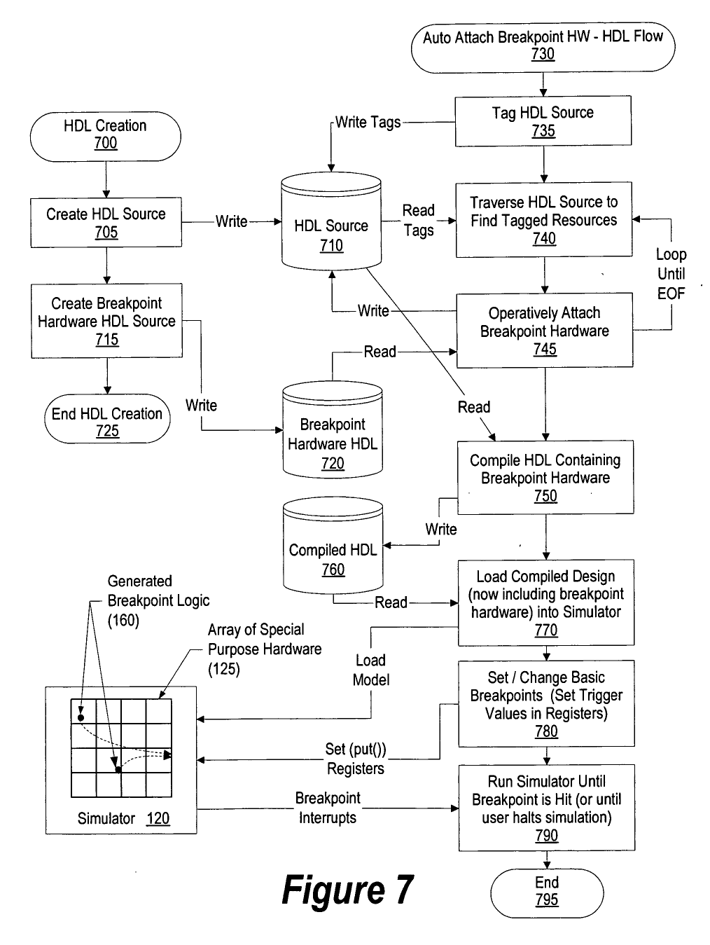

FIG. 7 is a flowchart depicting the creation of the hardware definition language for a model and the automatic attachment of breakpoint logic to the model. Creation of the hardware description file (HDL) commences at 700 with the hardware designer creating HDL source file 710 at step 705. At step 715, Breakpoint Hardware is designed in HDL and stored in Breakpoint Hardware HDL file 720. The Breakpoint Hardware is the hardware that is inserted in the model in order to capture basic events (see FIG. 3 for an example of breakpoint hardware used to track basic events including a counter and comparison values). Creation of the HDL source files ends at 725.

Processing used to automatically attach breakpoint hardware commences at 730. At step 735 the HDL source that describes the hardware to be tested is tagged in order to identify resources of interest. The tags are written to the HDL source stored in HDL source file 710. The tags can be provided by the designer (or other person tasked with testing the design) or can be traversed with a computer program that reads the HDL source to identify various resources and, when a resource is located, writes tags accordingly. At step 740, a computer program automatically traverses HDL source 710 in order to find tagged resources. At step 745, when a tagged resource is found, for example, a tagged register, breakpoint hardware corresponding to the resource is attached to the design by reading the breakpoint hardware HDL from file 720 and writing the breakpoint hardware HDL to HDL source 710. In this manner different breakpoint hardware HDL can be attached depending upon the type of the tagged resource. Traversal of the HDL source continues until all of the tagged resources have been identified and corresponding breakpoint hardware, if any, has been written to HDL source 710.

At step 750, HDL source 710 is read and compiled to compiled HDL source 760. The compiled source now includes the breakpoint hardware which was added in steps 740 and 745. At step 770, compiled HDL file 760 (a model of the design under test (DUT) along with the breakpoint hardware corresponding to tagged resources) is loaded into hardware simulator 120. The design under test and the breakpoints are stored in an array of special purpose hardware (125) included in the hardware simulator. Breakpoint logic 160 corresponds to the breakpoint hardware HDL that was added to the design and corresponds to tagged resources.

At step 780, the user of the simulator sets and changes basic breakpoints by setting [set( )] values in breakpoint hardware registers. For example, the user can turn a breakpoint on or off using a set( ) command and can provide a comparison value used to compare the resource being simulated. (See FIG. 3 where the user's set( ) value is stored in Reg 330 and comparator 325 is used to compare the value in Reg 330 with the value of the resource, such as a register, during simulation). At step 790, the simulator is started and runs until a breakpoint is reached, or until the user halts the simulation. The breakpoints can be any combination of basic breakpoints (shown in FIG. 3) and complex breakpoints (shown in FIGS. 4 and 5).

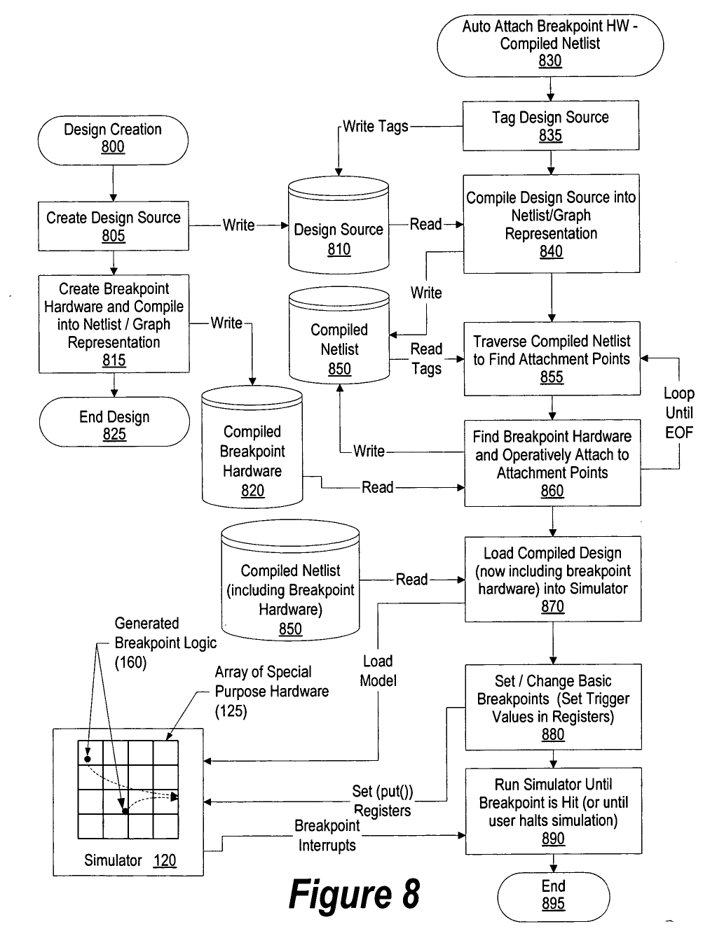

FIG. 8 is a flowchart depicting the creation hardware design source and the automatic attachment of breakpoint logic through a netlist. The flow shown in FIG. 8 is similar to that shown in FIG. 7. However, FIG. 7 shows HDL source that altered with automatically attached breakpoint hardware, while FIG. 8 shows more generic design source being compiled into a “netlist” and the compiled netlist being altered to automatically attach the breakpoint hardware. The description of the processing that takes place in FIG. 8, therefore, is similar to the description of FIG. 7. One difference is that the HDL source file is traversed to identify tagged resources and insert breakpoint logic (in FIG. 7), while in FIG. 8, the compiled netlist is traversed in order to identify tagged resources and insert breakpoint logic.

Creation of the design source file commences at 800 with the hardware designer creating design source file 810 at step 805. At step 815, Breakpoint Hardware is designed and compiled in Compiled Breakpoint Hardware file 820. The Breakpoint Hardware is the hardware that is inserted in the model in order to capture basic events. Creation of the HDL source files ends at 825.

Processing used to automatically attach breakpoint hardware commences at 830. At step 835 the design source that describes the hardware to be tested is tagged in order to identify resources of interest. The tags are written to the design source stored in source file 810. The tags can be provided by the designer (or other person tasked with testing the design) or can be traversed with a computer program that reads the design source to identify various resources and, when a resource is located, writes tags accordingly. At step 840, the design source is compiled into a netlist/graph representation and written to compiled netlist file 850. At step 855, the compiled netlist file is traversed in order to find tagged resources (attachment points) for breakpoint hardware. At step 860, when a tagged resource is found, for example, a tagged register, breakpoint hardware corresponding to the resource is attached to the design by reading the breakpoint hardware design from file 820 and writing the breakpoint hardware to compiled netlist file 850. In this manner different breakpoint hardware HDL are attached depending upon the type of the tagged resource. Traversal of the compiled design continues until all of the tagged resources have been identified and corresponding breakpoint hardware, if any, has been written to the compiled design file.

At step 870, compiled netlist file 860 (a model of the design under test (DUT) along with the breakpoint hardware corresponding to tagged resources) is loaded into hardware simulator 120. The design under test and the breakpoints are stored in an array of special purpose hardware (125) included in the hardware simulator. Breakpoint logic 160 corresponds to the breakpoint hardware HDL that was added to the design and corresponds to tagged resources.

At step 880, the user of the simulator sets and changes basic breakpoints by setting [set( )] values in breakpoint hardware registers. For example, the user can turn a breakpoint on or off using a set( ) command and can provide a comparison value used to compare the resource being simulated. (See FIG. 3 where the user's set( ) value is stored in Reg 330 and comparator 325 is used to compare the value in Reg 330 with the value of the resource, such as a register, during simulation). At step 890, the simulator is started and runs until a breakpoint is reached, or until the user halts the simulation. The breakpoints can be any combination of basic breakpoints (shown in FIG. 3) and complex breakpoints (shown in FIGS. 4 and 5).

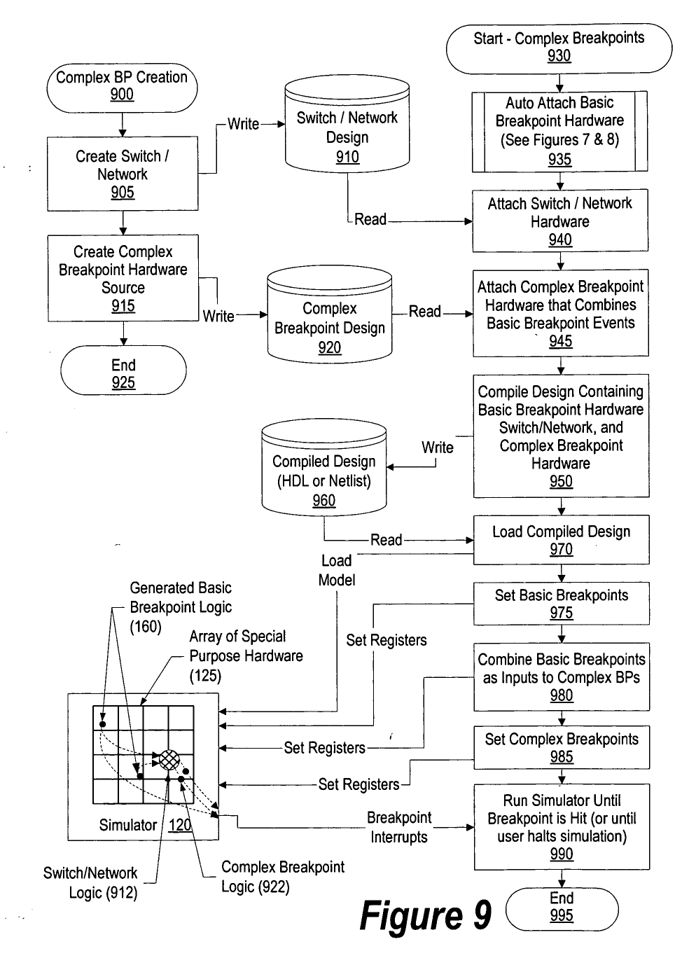

FIG. 9 is a flowchart depicting the addition of complex breakpoints to the design. Complex breakpoint creation commences at 900 whereupon, at step 905, a switch (or network), such as that shown in FIG. 6, is created (switch design 910). The switch allows basic breakpoint events to be combined into more complex breakpoints. At step 915, complex breakpoint hardware source is designed and stored in complex breakpoint file 920. Switch design 910 and complex breakpoint design 920 can be designed in HDL or using a design source that can be compiled into a netlist. An example of a complex breakpoint design is shown in FIG. 5 where basic breakpoint events are combined using combine logic 460 that includes an OR gate and an AND gate to create a complex breakpoint.

Returning to FIG. 9, complex breakpoint processing ends at 925 and processing that uses the complex breakpoint design and the switch design commences at 930. Basic breakpoint hardware is automatically attached at predefined process 935 (see FIG. 7 and corresponding text for a description of attaching basic breakpoint hardware using HDL, and see FIG. 8 and corresponding text for a description of attaching basic breakpoint hardware using a netlist).

At step 940, switch design 910 is included (attached) to the model, and at step 945, complex breakpoint design 920 is attached to the model. The attached switch design allows the simulation user, at run time, to map basic breakpoint events to complex breakpoint inputs. The complex breakpoints can be enabled or disabled (turned on or off) depending upon the testing that the simulation user wants perform. An example of a complex breakpoint design is shown in FIG. 5. In FIG. 5, user settable enable bits/latches (470) are ANDed with complex breakpoints (combine logic 460) to determine which complex breakpoints are returned from the hardware simulator (final breakpoints 480).

Returning to FIG. 9, at step 950 a compiled model design is created (compiled design 960) that includes the design under test (DUT), the basic breakpoint hardware automatically attached to the design in FIGS. 7 and 8, the switch/network hardware used to map basic events to complex breakpoint inputs, and the complex breakpoint hardware used to analyze basic breakpoint events and create final (complex) breakpoints that are returned from the simulator. In one embodiment, compiled design 960 is a compiled HDL, while in another embodiment, compiled design 960 is a compiled netlist.

At step 970, the compiled design is loaded into hardware simulator 120. The simulation user sets (using put( ) commands) basic breakpoint registers that enable/disable basic breakpoints as well as provide comparison values for the basic breakpoint logic (for example, when testing a register a breakpoint might be generated when the register contains a particular value of interest). The design under test, basic breakpoints, the switch/network, and the complex breakpoint logic are stored in an array of special purpose hardware (125) included in the hardware simulator. Basic breakpoint logic 160 corresponds to the basic breakpoint hardware HDL that was added to the design and corresponds to tagged resources. Switch logic 912 is the switch design, such as that shown in FIG. 6, that allows mapping of basic breakpoint events to complex breakpoint logic 922.

At step 980, the simulation user maps basic breakpoint events as inputs to complex breakpoint inputs using the switch/network that was included in the compiled design. In one embodiment, the simulation user uses settable register values to provide the switch with such mapping information. In step 985, the complex breakpoints are enabled by setting the enable bits. In addition, complex breakpoints can also include user-settable registers that can be used to compare the complex breakpoint to a user-settable value. For example, a complex breakpoint can be configured to receive input from multiple basic breakpoint events that correspond to various registers. The complex breakpoint logic could OR or AND the registers together and compare the registers to a particular value. In this manner, a complex breakpoint can be established that is triggered when any of a set of registers is equal to a particular value, or a complex breakpoint can be established that is triggered when multiple registers are all equal to a particular value.

At step 990, the user starts the hardware simulator and the loaded simulation runs until a breakpoint is reached (either a basic event that is enabled or a complex “final” breakpoint). Allowing both basic and complex breakpoints allows the simulation user flexibility in they types of breakpoint data being returned. For example, the user can use complex breakpoints to determine when a general situation occurs and, when the general situation occurs, the user can enable more basic breakpoint events to further identify and analyze the state of the design under test (DUT).

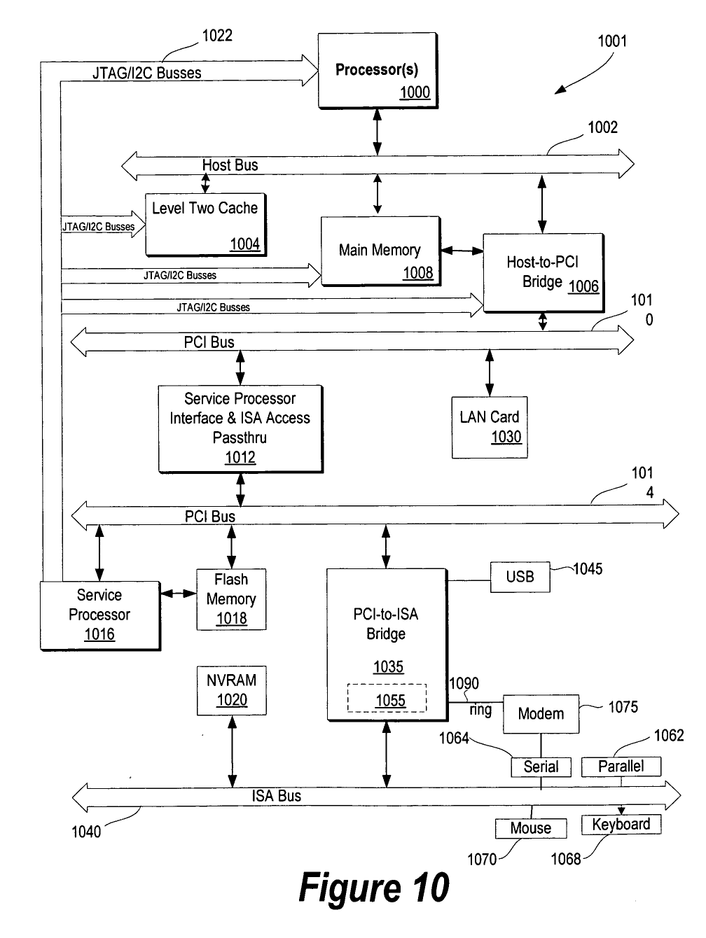

FIG. 10 illustrates information handling system 1001 which is a simplified example of a computer system capable of performing the computing operations described herein. Computer system 1001 includes processor 1000 which is coupled to host bus 1002. A level two (L2) cache memory 1004 is also coupled to host bus 1002. Host-to-PCI bridge 1006 is coupled to main memory 1008, includes cache memory and main memory control functions, and provides bus control to handle transfers among PCI bus 1010, processor 1000, L2 cache 1004, main memory 1008, and host bus 1002. Main memory 1008 is coupled to Host-to-PCI bridge 1006 as well as host bus 1002. Devices used solely by host processor(s) 1000, such as LAN card 1030, are coupled to PCI bus 1010. Service Processor Interface and ISA Access Pass-through 1012 provides an interface between PCI bus 1010 and PCI bus 1014. In this manner, PCI bus 1014 is insulated from PCI bus 1010. Devices, such as flash memory 1018, are coupled to PCI bus 1014. In one implementation, flash memory 1018 includes BIOS code that incorporates the necessary processor executable code for a variety of low-level system functions and system boot functions.

PCI bus 1014 provides an interface for a variety of devices that are shared by host processor(s) 1000 and Service Processor 1016 including, for example, flash memory 1018. PCI-to-ISA bridge 1035 provides bus control to handle transfers between PCI bus 1014 and ISA bus 1040, universal serial bus (USB) functionality 1045, power management functionality 1055, and can include other functional elements not shown, such as a real-time clock (RTC), DMA control, interrupt support, and system management bus support. Nonvolatile RAM 1020 is attached to ISA Bus 1040. Service Processor 1016 includes JTAG and I2C busses 1022 for communication with processor(s) 1000 during initialization steps. JTAG/I2C busses 1022 are also coupled to L2 cache 1004, Host-to-PCI bridge 1006, and main memory 1008 providing a communications path between the processor, the Service Processor, the L2 cache, the Host-to-PCI bridge, and the main memory. Service Processor 1016 also has access to system power resources for powering down information handling device 1001.

Peripheral devices and input/output (I/O) devices can be attached to various interfaces (e.g., parallel interface 1062, serial interface 1064, keyboard interface 1068, and mouse interface 1070 coupled to ISA bus 1040. Alternatively, many I/O devices can be accommodated by a super I/O controller (not shown) attached to ISA bus 1040.

In order to attach computer system 1001 to another computer system to copy files over a network, LAN card 1030 is coupled to PCI bus 1010. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method comprising:
identifying breakpoint logic corresponding to a plurality of resources included in a hardware design source file;
loading, into a hardware simulator, a hardware design file into a hardware simulator, wherein the hardware design file includes a hardware design corresponding to the hardware design source file and one or more breakpoint logics that corresponding to one or more of the plurality of resources;
after the loading, selectively enabling, at the hardware simulator, one or more of the breakpoint logics; and
simulating the hardware design on the hardware simulator, wherein the hardware simulator halts when one of the enabled breakpoint logics is triggered.

2. The method of claim 1 further comprising:
receiving, from the hardware simulator, state information generated during the simulating at a point in time when the enabled breakpoint logic was triggered.

3. The method of claim 1 further comprising:
prior to the identifying, selecting the plurality of resources from a plurality of hardware resources included in the hardware design file, the selecting including tagging the plurality of resources in order to indicate the resources and a resource type associated with each resource.

4. The method of claim 1 further comprising:
receiving, at the hardware simulator after the loading, one or more comparison values;
storing the received comparison values in one or more register locations maintained by the hardware simulator;
during simulation, comparing values of the resources corresponding to the enabled breakpoint logic to the comparison values; and
triggering a breakpoint that halts the simulator in response to the comparison.

5. The method of claim 1 further comprising:
providing counter logic in one of the enabled breakpoint logics that corresponds to one of the resources;
receiving, at the hardware simulator after the loading, a counter comparison value and a resource comparison value;
storing the received counter comparison value and the resource comparison value in register locations maintained by the hardware simulator;
during simulation:
comparing values of the resource that corresponds to the counter logic to the resource comparison value;
incrementing a counter maintained by the counter logic in response to the comparison;
determining whether the counter has reached the counter comparison value; and
triggering a breakpoint that halts the simulator in response to the determination.

6. The method of claim 1 wherein the identifying further comprises:
detecting a resource type corresponding to each of the plurality of resources;
retrieving breakpoint logic that corresponds to the resource type for each of the resources;
attaching the retrieved breakpoint logic to the hardware design source file;
tagging resources identified by HDL attributes of the resources when the hardware design source file is in an HDL format; and
tagging resources identified in a netlist when the hardware design source file is in a netlist format.

7. The method of claim 1 further comprising:
creating the hardware design source file;
creating a plurality of breakpoint logics;
tagging a plurality of the resources;
attaching one of the breakpoint logics to the hardware design source file for each of the tagged resources based upon the type of each resource;
compiling the hardware design source file;
wherein the selective enabling includes writing values to registers maintained by the hardware simulator;
receiving, at the hardware simulator after the loading, one or more comparison values for one or more of the enabled breakpoint logics;
storing the received comparison values in one or more register locations maintained by the hardware simulator;
during simulation, comparing values of the resources corresponding to the enabled breakpoint logic to the comparison values; and
triggering a breakpoint that halts the simulator in response to the comparison.

8. An information handling system comprising:
one or more first processors;
a first memory accessible by the first processors;
a nonvolatile storage accessible by one or more of the first processors;
an interface connecting the information handling system to a hardware simulator, wherein the hardware simulator includes one or more second processors and a second memory accessible by the second processors;
a simulation tool for providing interactive breakpoints, the simulation tool comprising software code effective to:
identify breakpoint logic corresponding to a plurality of resources included in a hardware design source file;
load, into the hardware simulator, a hardware design file into a hardware simulator, wherein the hardware design file includes a hardware design corresponding to the hardware design source file and one or more breakpoint logics that corresponding to one or more of the plurality of resources;
selectively enable, at the hardware simulator after the simulation has been loaded, one or more of the breakpoint logics; and
run the hardware simulator, wherein the hardware simulator simulates the hardware design and halts when one of the enabled breakpoint logics is triggered.

9. The information handling system of claim 8 further comprising software code effective to:
receive, from the hardware simulator, state information generated during the simulating at a point in time when the enabled breakpoint logic was triggered.

10. The information handling system of claim 8 further comprising:
prior to the identification of the breakpoint logic, a means for selecting the plurality of resources from a plurality of hardware resources included in the hardware design file, the means for selecting including a means for tagging the plurality of resources in order to indicate the resources and a resource type associated with each resource.

11. The information handling system of claim 8 further comprising software code effective to:
receive, at the hardware simulator after the hardware design file has been loaded, one or more comparison values;
store the received comparison values in one or more register locations stored in the second memory;
during simulation, compare values of the resources corresponding to the enabled breakpoint logic to the comparison values; and
trigger a breakpoint that halts the simulator in response to the comparison.

12. The information handling system of claim 8 further comprising software code effective to:
provide counter logic in one of the enabled breakpoint logics that corresponds to one of the resources;
receive, at the hardware simulator after the hardware design file has been loaded, a counter comparison value and a resource comparison value;
store the received counter comparison value and the resource comparison value in register locations stored in the second memory;
during simulation, software code effective to:
compare values of the resource that corresponds to the counter logic to the resource comparison value;
increment a counter maintained by the counter logic in response to the comparison;
determine whether the counter has reached the counter comparison value; and
trigger a breakpoint that halts the simulator in response to the determination.

13. The information handling system of claim 8 wherein identification of the breakpoint logic further comprises software code effective to:
detect a resource type corresponding to each of the plurality of resources;
retrieve breakpoint logic that corresponds to the resource type for each of the resources;
attach the retrieved breakpoint logic to the hardware design source file;
tagging resources identified by HDL attributes of the resources when the hardware design source file is in an HDL format; and
tagging resources identified in a netlist when the hardware design source file is in a netlist format.

14. The information handling system of claim 8 further comprising software code effective to:
create the hardware design source file;
create a plurality of breakpoint logics;
tag a plurality of the resources;
attach one of the breakpoint logics to the hardware design source file for each of the tagged resources based upon the type of each resource;
compile the hardware design source file, wherein the selectively enabling includes software code effective to write values to registers stored in the second memory;
receive, at the hardware simulator after the hardware design file has been loaded, one or more comparison values for one or more of the enabled breakpoint logics;
store the received comparison values in one or more register locations stored in the second memory;
during simulation, compare values of the resources corresponding to the enabled breakpoint logic to the comparison values; and
trigger a breakpoint that halts the simulator in response to the comparison.

15. A computer program product comprising:
computer operable medium having computer program code, the computer program code being effective to:
identify breakpoint logic corresponding to a plurality of resources included in a hardware design source file;
load, into a hardware simulator, a hardware design file into a hardware simulator, wherein the hardware design file includes a hardware design corresponding to the hardware design source file and one or more breakpoint logics that corresponding to one or more of the plurality of resources;
selectively enable, at the hardware simulator, one or more of the breakpoint logics;
run the hardware simulator, wherein the hardware simulator simulates the hardware design and halts when one of the enabled breakpoint logics is triggered; and
return, from the hardware simulator, state information corresponding to the hardware design at the point when the enabled breakpoint logic was triggered.

16. The computer program product of claim 15 further comprising software code effective to:
receive, from the hardware simulator, state information generated during the simulating at a point in time when the enabled breakpoint logic was triggered.

17. The computer program product of claim 15 further comprising:
software code effective to, prior to the identification of breakpoint logic, select the plurality of resources from a plurality of hardware resources included in the hardware design file, the selection of resources including software code effective to tag the plurality of resources.

18. The computer program product of claim 15 further comprising software code effective to:
receive, at the hardware simulator after the loading, one or more comparison values;
store the received comparison values in one or more register locations maintained by the hardware simulator;
during simulation, compare values of the resources corresponding to the enabled breakpoint logic to the comparison values; and
trigger a breakpoint that halts the simulator in response to the comparison.

19. The computer program product of claim 15 further comprising software code effective to:
provide counter logic in one of the enabled breakpoint logics that corresponds to one of the resources;
receive, at the hardware simulator after the hardware design file has been loaded, a counter comparison value and a resource comparison value;
store the received counter comparison value and the resource comparison value in register locations maintained by the hardware simulator;
during simulation:
compare values of the resource that corresponds to the counter logic to the resource comparison value;
increment a counter maintained by the counter logic in response to the comparison;
determine whether the counter has reached the counter comparison value; and
trigger a breakpoint that halts the simulator in response to the determination.

20. The computer program product of claim 15 wherein the identification of the breakpoint logic further comprises software code effective to:
detect a resource type corresponding to each of the plurality of resources;
retrieve breakpoint logic that corresponds to the resource type for each of the resources;
attach the retrieved breakpoint logic to the hardware design source file;
tag resources identified by HDL attributes of the resources when the hardware design source file is in an HDL format; and
tag resources identified in a netlist when the hardware design source file is in a netlist format
